(19) United States
(12) Patent Application Publication
(10) Pub. No.: US 2012/0184407 A1
(43) Pub. Date: Jul. 19, 2012

(54) METHOD AND MEANS FOR CONTROLLING THE DOWNSHIFTING

(75) Inventors: Martin GENTILE, Koenigstaedten (DE); Gernot BECKER, Mainz (DE); Wolfgang MOSER, Wiesbaden (DE); Karlheinz SCHMITT, Hattersheim (DE)

(73) Assignee: GM GLOBAL TECHNOLOGY OPERATIONS LLC, Detroit, MI (US)

(21) Appl. No.: 13/349,256

(22) Filed: Jan. 12, 2012

(30) Foreign Application Priority Data
Jan. 14, 2011 (DE) 102011008597.1

(51) Int. Cl. B60W 10/10; B60W 10/06

(52) U.S. Cl. 477/118

(57) ABSTRACT

A method is provided for controlling a downshifting of a transmission of a motor vehicle in coasting mode from a staring gear into a target gear. The method includes, but is not limited to estimating an output torque exerted by the engine with starting gear engaged, calculating a set point torque by means of the output torque and the transmission ratios of starting and target gear, and activating the engine with engaged target gear subject to the presetting of the calculated set point torque.

### CROSS-REFERENCE TO RELATED APPLICATION

This application claims priority to German Patent Application No. 102011008597.1, filed Jan. 14, 2011, which is incorporated herein by reference in its entirety.

### TECHNICAL FIELD

The technical field relates to a method for controlling the downshifting of a transmission of a motor vehicle, as well as a computer and a computer program product for carrying out the method.

### BACKGROUND

Although when driving in coasting mode the engine of a motor vehicle is connected to the chassis by way of the manual transmission, it is not, however, supplied with fuel so that the movement of the vehicle keeps the engine running and not the other way around. When rolling on a level or rising road surface, this leads to a continuous deceleration of the vehicle and, accordingly, to a reduction of the rotational speed of the engine.

Conventional automatic gear changes are equipped to select and engage in the transmission a gear of the transmission by means of the engine rotational speed and/or the vehicle speed. In general, limit values of the speed and/or of the rotational speed are defined for each gear, the undershooting of which results in that the next lower gear is automatically engaged. When a vehicle rolls on a level road surface in coasting mode, these limit values are successively undershot. Such downshifting in each case leads to a rotational speed increase of the engine and to an increase of its deceleration effect. An abrupt change of the deceleration is perceived as impairment of the travelling comfort. Although it is conceivable per se to bring about a gradual change of the deceleration through slow closing of the clutch, but an unnecessarily long sojourn of the clutch in a partly open state leads to increased friction wear and is therefore undesirable.

At least one object is to create a method for controlling the downshifting of a motor vehicle transmission that avoids an impairment of the travelling comfort through abrupt deceleration change. In addition, other objects, desirable features, and characteristics will become apparent from the subsequent summary and detailed description, and the appended claims, taken in conjunction with the accompanying drawings and this background.

### SUMMARY

A method is provided for controlling a downshifting of a transmission of a motor vehicle in coasting mode from a starting gear into a target gear with the steps of: a) estimating a starting torque exerted by the engine with the starting gear engaged, b) calculating a setpoint torque for the target gear by means of the starting torque and the transmission ratio of starting gear and target gear, and c) activating the engine with engaged target gear subject to the presetting of the calculated setpoint torque.

The product of starting torque and starting rotational speed is a dimension for the power absorbed by the engine before the downshifting drawn from the kinetic energy of the vehicle, i.e., for the deceleration effect of the engine. In order for this power and as a consequence the deceleration of the vehicle after the downshifting to be the same as before, the product of torque and transmission ratio after the downshifting has to remain the same. This requirement results in the setpoint torque to be generated by the engine after the downshifting.

Preferably, the method is employed when the vehicle rolls out entirely without drive, for example, when approaching a red traffic light. In this case, the estimation of the starting torque in step a) takes place entirely without supply of fuel to the engine. However, also conceivable is an application in cases where the driver actuates the accelerator pedal of the vehicle but not forcefully enough in order to maintain the speed of the vehicle.

The estimation of the starting torque can take place based on the rotational speed of the engine by means of a preset function, which can be stored as table or as computation instruction. Apart from the rotational speed, this function can also depend on other influence factors measurable on the engine or transmission, in particular on their temperature. It is also conceivable to determine the starting torque by means of the time change of a speed-based measurement quantity such as for example the vehicle speed or the rotational speed of the engine or any other rotating component of the drive train of the vehicle. Such a change can be directly utilized for estimating the starting torque, or it can serve for the continuous updating of the preset function mentioned above.

Unforeseen environmental influences can be taken into account in that the deceleration of the vehicle following the engagement of the target gear is compared with the deceleration before disengaging the starting gear and in the event of a significant difference between the decelerations; the set point torque is readjusted. Following the engaging of the target gear a fuel supply required for generating the setpoint torque calculated in step b) can be gradually reduced so that the deceleration of the vehicle gradually reaches the value to be expected for a fewer coasting mode in the target gear.

In order to avoid a shock that can be felt by the vehicle occupants that would result if upon engaging of the target gear the engine would be abruptly accelerated via the transmission, the engine can be supplied with a metered amount of fuel even during the shifting in order to accelerate said engine before the target gear is engaged.

A computer, particularly an engine control unit for a motor vehicle, which is equipped to carry out the method described above, or a computer program product with program code means more preferably stored on a data carrier, which enable a computer to carry out the method described above, is also an embodiment.

### BRIEF DESCRIPTION OF THE DRAWINGS

The present invention will hereinafter be described in conjunction with the following drawing figures, wherein like numerals denote like elements, and:

FIG. 1 is a schematic representation of a drive train of a motor vehicle subjected to the method according an embodiment;

FIG. 2 is a flow diagram of the method according to the embodiment;

FIG. 3 is the time development of rotational speed and engine torque when carrying out the method according to FIG. 2; and

FIG. 4 is a flow diagram of additional steps of a further development of the method of FIG. 2.

### DETAILED DESCRIPTION

The following detailed description is merely exemplary in nature and is not intended to limit application and uses. Furthermore, there is no intention to be bound by any theory presented in the preceding background or the following detailed description.

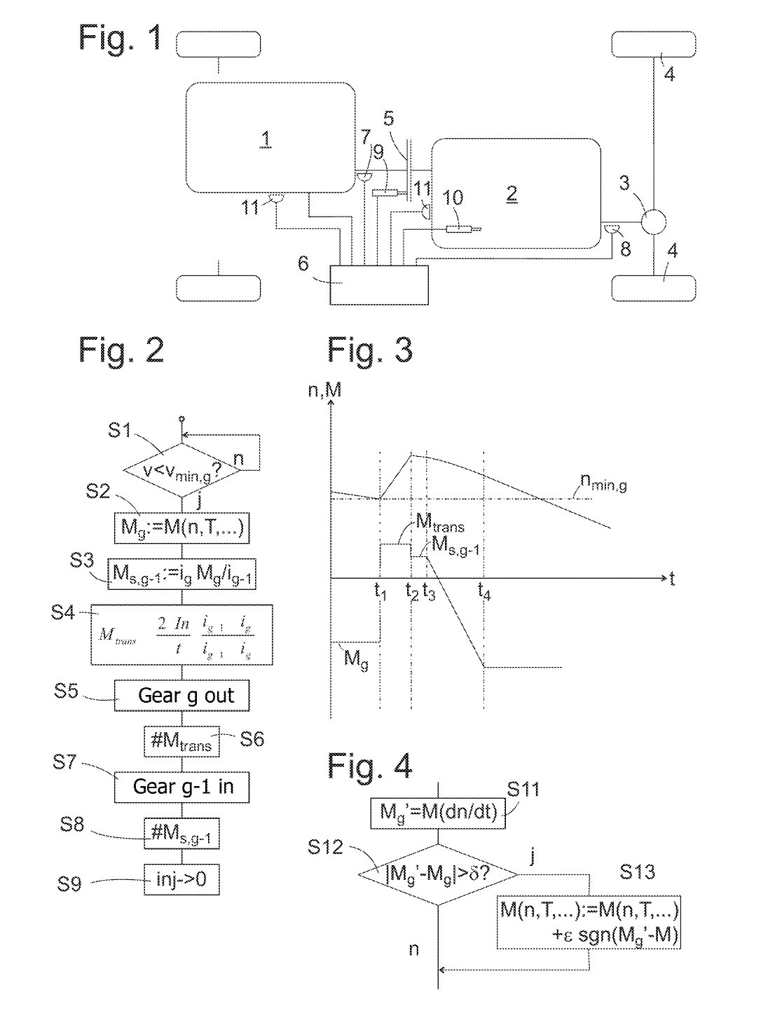

FIG. 1 is a block diagram of a motor vehicle drive system implementing the embodiment with a combustion engine 1, a stepped transmission 2, a differential 3, and wheels 4 driven via the differential 3. The stepped transmission 2 can be an automated shift transmission that is connected to the combustion engine 1 via a clutch 5, or an automatic transmission, wherein a torque converter takes over the function of the clutch. In the following, for the sake of simplicity, however, only the clutch 5 will be discussed. However, it is to be understood that the functions of said clutch, as soon as these are relevant to the present invention, can also be carried out by the torque converter.

An electronic control unit 6 monitors and controls the fuel supply of the combustion engine 1 corresponding to the actuation of an accelerator pedal by the driver or corresponding to a presetting by a driver assistance system (not shown). In addition, it controls the gear engaged in the stepped transmission 2 by means of the rotational speed sensed by a rotational speed sensor 7 on the output shaft of the engine 1 and/or of the speed of the vehicle, which can be obtained with the help of a speedometer sensor 8 sensing the rotational speed of a shaft of the drive train located on the output side of the stepped transmission 2.

In order to control a gear change, the control unit 6 acts on the clutch 5 and on the stepped transmission 2 via actuators 9, 10. The control unit 6 can be a microcomputer with a single processor, which accomplishes both the control of the combustion engine 1 as well as that of the clutch 5 and of the transmission 2; however, it can also comprise two separate processors, of which a first one controls the engine and the second one the gear selection and makes available to the first processor information necessary for the engine control concerning a currently engaged gear or a gear soon to be engaged next. The second processor controlling the transmission and the clutch can also be omitted in favor of a conventional hydraulic automatic gear change, provided the processor controlling the engine 1 is connected to the required sensors in order to detect the respective gear currently engaged and a gear to be engaged next if applicable by means of measured rotational speeds and/or speeds all or pressures measured in the automatic gear change. The control unit 6 is furthermore connectable to sensors 11 for sensing the temperature of the engine 1 and of the transmission 2 as well as of other operating parameters connected with losses of the engine 1 and of the transmission 2.

FIG. 2 shows a flow diagram of an exemplary operating method of the control unit 6. With the description, it is assumed that at the start of the method a gear g is engaged in the transmission 2 and that this gear g is known to the control unit 6. Furthermore, it is assumed for the sake of simplicity that the gear selection is merely based on the vehicle speed v. It is to be understood however that further criteria such as the rotational speed of the engine 1 can be taken into account instead of or in addition to the speed v.

In step S1, the control unit 6 checks if a condition for the downshifting, here the undershooting of a minimum speed v_{min,g} is satisfied for the current gear g. For as long as this is not the case, the step S1 is regularly repeated. Once the downshift criterion is satisfied, at the latest, the control unit 6 estimates the torque M_{g} acting on the output shaft of the engine 1. When the vehicle is purely in coasting mode, i.e. when the accelerator is not actuated and the engine 1 is consequently not supplied with fuel, this torque M_{g} is a function M(n,T) of the engine rotational speed n and the temperature. This function M(n,T) is always negative, i.e. the torque M_{g} has a decelerating effect on the vehicle. The amount of M slightly increases with the rotational speed n and, because of the improved lubricity of the engine oil with increasing temperature T, decreases with the temperature T. Preferentially, the function M(n,T) is stored in a memory of the control unit 6 in the form of a search table.

In step S3 the control unit 6 calculates a setpoint torque of the engine M_{s,g-1}, which the engine 1 upon downshifting in the next lower gear g-1 would have to exert so that the downshifting remains without effect on the deceleration of the vehicle. This setpoint torque M_{s,g-1} is obtained by multiplication of the current torque M_{g} with a correction factor derived from the transmission ratios i_{g}, i_{g-1} of the gears g, g-1:

$${M}_{s , g - 1} = \frac{{i}_{g}}{{i}_{g - 1}} {M}_{g} .$$

In order to avoid that an abrupt rotational speed increase of the engine 1 driven by the vehicle movement following the downshifting in the gear g-1 results in a shock that is noticeable to the occupants it is practical during the downshifting to increase the rotational speed of the engine from the rotational speed n at the time of the shifting decision to the value i_{g-1}*n/i_{g}. The kinetic energy of the rotating parts of the engine required for this now is:

$$Δ {E}_{kin} = \frac{{π}^{2}}{2} I ( \frac{{i}_{g - 1}^{2}}{{i}_{g}^{2}} - 1 ) {n}^{2} ,$$

where I describes the moment of inertia of the rotating parts of the engine 1. If Δt is the duration of the shifting operation available for increasing the rotational speed, the mean torque to be exerted by the engine in this time is obtained as:

$${M}_{trans} = \frac{2 π In}{Δ t} ( \frac{{i}_{g - 1} - {i}_{g}}{{i}_{g - 1} + {i}_{g}} ) ( S 4 ) .$$

As soon as in step S5 the starting gear g is disengaged, the control unit 6 signals to the engine 1 the setpoint torque Mₜᵣₐₙₛ (S6), which said engine has to generate in order to increase its rotational speed during the course of the shifting operation to i_{g-1}*n/i_{g}. When in step S7 the gear g-1 is engaged, the engine 1 therefore has reached the corresponding suitable rotational speed, i.e. parts of the clutch 5 on the drive side and output side rotate at the same speed. Following the closing of the clutch 5, the engine 1 is activated in step S8 with the setpoint torque M_{s,g-1} calculated in step S3. The deceleration of the vehicle is therefore no different after engaging the target gear g-1 than prior to the shifting, and the shifting operation is therefore not perceptible to the vehicle occupants.

Only after the shifting will the fuel supply to the engine 1 be gradually reduced from the value required for generating the torque M_{s,g-1} back to zero in step S9, in order to let the vehicle continue to roll in coasting mode. The duration of this step S9 can be as long as required in order to avoid letting the increase of the deceleration become perceptible to the vehicle occupants.

FIG. 3 schematically shows the time curve of the rotational speed and the torque of the engine 1 during a downshift operation. A dash-dotted horizontal line in FIG. 3 describes the limit rotational speed n_{min,g} of the engine corresponding to the limit speed v_{min,g} in the gear g. In a time span before the time t₁ corresponding to the repeated execution of the step S1 the rotational speed n uniformly decreases until at the time t₁ the shifting threshold is reached. The torque of the engine is constantly negative at M_{g}. At the start of the shifting operation, it assumes the positive value Mₜᵣₐₙₛ, and the rotational speed n uniformly rises until at the time t₂ the target gear g-1 is engaged. The setpoint torque M_{s,g-1} applicable from t₂ is smaller than Mₜᵣₐₙₛ and can, deviating from the representation of FIG. 3, also be between zero and M_{g}.

In the representation of FIG. 3 a time interval [t2, t3] exists between the steps S8 and S9, in which the control unit 6 maintains the setpoint torque Ms,g-1 unchanged and in which the deceleration of the vehicle is the same as before the time t1 . The duration of this time interval can also be zero, however. From the time t3, the control unit 6 gradually reduces the fuel supply to the engine 1. As is evident from the development of the rotational speed in FIG. 3, the deceleration of the vehicle also increases gradually until at the time t4 the fuel supply is again zero and the deceleration again reaches a constant value. If it is not the lowest gear of the transmission 2, the gear g-1 so reached in turn can serve as starting gear for a repetition of the method.

The torque determined in step S2 by means of the search table M(n,T) need not necessarily coincide exactly with that actually exerted by the engine 1. Deviations can for example be due to manufacturing tolerances between an engine used for creating the search table and the engine 1 of the vehicle or due to ageing manifestations of the engine 1. Such inaccuracies could be avoided in principle by determining the engine torque M_{g} in real time in each case. Such a real time determination, which can be based on the time change of the vehicle speed or a quantity which has a fixed known relationship with said vehicle speed such as for example the rotational speed, however has the problem that it is influenced by environmental influences such as for example an incline of the road surface that is different from zero or the rolling resistance of the vehicle that is dependent on the quality of the road surface. Since these influences tend to balance out on average, such a real time determination can be practically employed for a running updating of the search table.

Such an updating can be carried out for example in that the steps shown in FIG. 4 are inserted in the method of FIG. 2 at any point between step S1 and S5. In step S11, an alternative value M_{g}′ of the engine torque is initially calculated as a function of vehicle mass and vehicle deceleration. The vehicle deceleration can be directly measured for example by an inertia sensor or it can be numerically calculated as time derivative from speed values or from values of a quantity, such as for example the engine rotational speed, that has an unambiguous relationship with the vehicle speed. In step S12, it is decided if this alternative value and the value of the engine torque calculated after step S2 differ significantly by more than a limit value δ. If there is such a significant difference, the search table M(n,T) is corrected in step S13. The correction in each case relates only to that value of the search table that corresponds to the current parameter values of n and T and has been utilized for determining the engine torque in step S2. In each case, this value is increased or reduced by a fixed small increment ε, depending on which of both is necessary in order to reduce the difference between the two torque values M(n,T) and M_{g}′. The smaller ε, the greater the number of measurements that is required in order to make the search table agree with the true value of the engine torque, but the more completely is the influence of a road surface inclination randomly varying from one measurement to the other averaged.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for controlling a downshifting of a transmission of a motor vehicle in a coasting mode from a starting gear into a target gear, comprising:
estimating an output torque exerted by an engine with an engaged starting gear;
calculating a set point torque with a starting torque and a plurality of transmission ratios of the starting gear and the target gear; and
activating the engine with an engaged target gear subject to the presetting of the set point torque.

2. The method according to claim 1, wherein the estimating comprises estimating the output torque without a supply of fuel to the engine.

3. The method according claim 1, further comprising estimating the starting torque with a predetermined function of a rotational speed of the engine.

4. The method according claim 1, further comprising determining the output torque with a change of a speed-based measurement quantity.

5. The method according to claim 1, further comprising:
comparing a first deceleration of the motor vehicle after engaging the target gear with a second deceleration before disengaging the starting gear;
adjusting the set point torque if a significant difference exists between the first deceleration and the second deceleration.

6. The method according to claim 1, further comprising gradually reducing a fuel supply following the engaging of the target gear.

7. The method according to claim 1, further comprising accelerating the engine after disengaging the starting gear and before engaging the target gear.

8. A computer readable medium embodying a computer program product, said computer program product comprising:
a control program for controlling a downshifting of a transmission of a motor vehicle in a coasting mode from a starting gear into a target gear, the control program configured to:
estimate an output torque exerted by an engine with an engaged starting gear;
calculate a set point torque with a starting torque and a plurality of transmission ratios of the starting gear and the target gear; and
activate the engine with an engaged target gear subject to the presetting of the set point torque.

9. The computer readable medium embodying the computer program product according to claim 8, wherein the control program is configured to estimate the output torque without a supply of fuel to the engine.

10. The computer readable medium embodying the computer program product according to claim 8, wherein the control program is further configured to estimate the starting torque with a predetermined function of a rotational speed of the engine.

11. The computer readable medium embodying the computer program product according to claim 8, wherein the control program is further configured to determine the output torque with a change of a speed-based measurement quantity.

12. The computer readable medium embodying the computer program product according to claim 8, wherein the control program is further configured to:
compare a first deceleration of the motor vehicle after engaging the target gear with a second deceleration before disengaging the starting gear; and
adjust the set point torque if a significant difference exists between the first deceleration and the second deceleration.

13. The computer readable medium embodying the computer program product according to claim 8, wherein the control program is further configured to gradually reduce a fuel supply following the engaging of the target gear.

14. The computer readable medium embodying the computer program product according to claim 8, wherein the control program is further configured to accelerate the engine after a disengagement of the starting gear and before an engagement of the target gear.
